(19) United States
(12) Patent Application Publication
(10) Pub. No.: US 2017/0344175 A1
(43) Pub. Date: Nov. 30, 2017

(54) PORTABLE ELECTRONIC DEVICES AND OPERATING METHODS THEREOF

(71) Applicant: Quanta Computer Inc., Taoyuan City (TW)

(72) Inventor: Li-Te HUNG, Taoyuan City (TW)

(21) Appl. No.: 15/233,252

(22) Filed: Aug. 10, 2016

(30) Foreign Application Priority Data
May 30, 2016 (TW) 105116826

(51) Int. Cl. G06F 3/041; G06F 3/01; G06F 3/0488; G09G 3/20

(52) U.S. Cl. CPC G06F 3/0416; G06F 3/0488; G06F 3/017; G09G 2320/0626; G09G 3/2003

(57) ABSTRACT

A portable electronic device includes a three-axis acceleration sensor, a touch-sensing module, a processor, and a display screen. The three-axis acceleration sensor outputs a first sensing signal according to the state of motion. The touch-sensing module generates a touch-sensing signal according to the touch action of a touching object. The processor receives the first sensing signal and the touch-sensing signal, executes the user interface, and determines that the portable electronic device is in a state of motion when the first sensing signal is greater than a predetermined threshold. When the portable electronic device is in a state of motion, the processor continuously receives the touch-sensing signal and the user interface is in a normal mode rather than a call mode for longer than a predetermined time, the processor controls the display screen to decrease the brightness for entering a safe operation mode.

### CROSS REFERENCE TO RELATED APPLICATIONS

This application claims priority of Taiwan Patent Application No. 105116826, filed on May 30, 2016, the entirety of which is incorporated by reference herein.

### BACKGROUND OF THE INVENTION

### Field of the Invention

The application relates in general to a portable electronic device and a portable electronic device operating method, and in particular to a portable electronic device and a portable electronic device operating method that adjust the brightness of the display screen according to the state of motion of the portable electronic device.

### Description of the Related Art

Because of advances in technology and portable electronic devices that are easy to carry, portable electronic devices are used widely. However, it may be dangerous for a user to use a portable electronic device while in motion, because the user will focus his attention on the portable electronic device rather than on his surroundings. Thus, how to suitably remind the user to pay attention to the surroundings when using the portable electronic device while moving is a problem which needs to be solved immediately.

### BRIEF SUMMARY OF INVENTION

An embodiment of the present invention provides a portable electronic device, including a three-axis acceleration sensor, a touch-sensing module, a processor, and a display screen. The three-axis acceleration sensor outputs a first sensing signal according to the state of motion of the portable electronic device. The touch-sensing module generates a touch-sensing signal according to a touch action made by a touching object. The processor receives the first sensing signal and the touch-sensing signal, and executes a user interface. When the first sensing signal is greater than a predetermined threshold, the processor determines that the portable electronic device is in a state of motion. The display screen displays the user interface. When the portable electronic device is in a state of motion, the processor continuously receives touch-sensing signals and when the user interface is in a normal mode rather than a call mode for longer than a predetermined time, the processor controls the display screen to decrease the brightness from an original value to a first value for entering a safe operation mode.

Another embodiment of the present invention provides a portable electronic device operating method, the steps of which include: a three-axis acceleration sensor outputs a first sensing signal according to the state of motion of a portable electronic device; a touch-sensing module generates a touch-sensing signal according to a touch action made by a touching object; a processor receives the first sensing signal and the touch-sensing signal; the processor executes the user interface; the processor determines whether the first sensing signal is greater than a predetermined threshold; the processor determines that the portable electronic device is in a state of motion when the first sensing signal is greater than a predetermined threshold; and the processor controls a display screen to decrease its brightness from an original value to a first value for entering a safe operation mode when the portable electronic device is in a state of motion, the processor continuously receives the touch-sensing signal and the user interface is in a normal mode rather than a call mode for longer than a predetermined time.

### BRIEF DESCRIPTION OF DRAWINGS

The invention can be more fully understood by reading the subsequent detailed description and examples with references made to the accompanying drawings, wherein:

FIG. 1 is a block diagram of the portable electronic device in accordance with an embodiment of the invention.

FIG. 2 is a flow chart of the portable electronic device operating method in accordance with an embodiment of the invention.

### DETAILED DESCRIPTION OF INVENTION

Further areas to which the present devices and methods can be applied will become apparent from the detailed description provided herein. It should be understood that the detailed description and specific examples, while indicating exemplary embodiments of a portable electronic device and a portable electronic device operating method, are intended for the purposes of illustration only and are not intended to limit the scope of the invention.

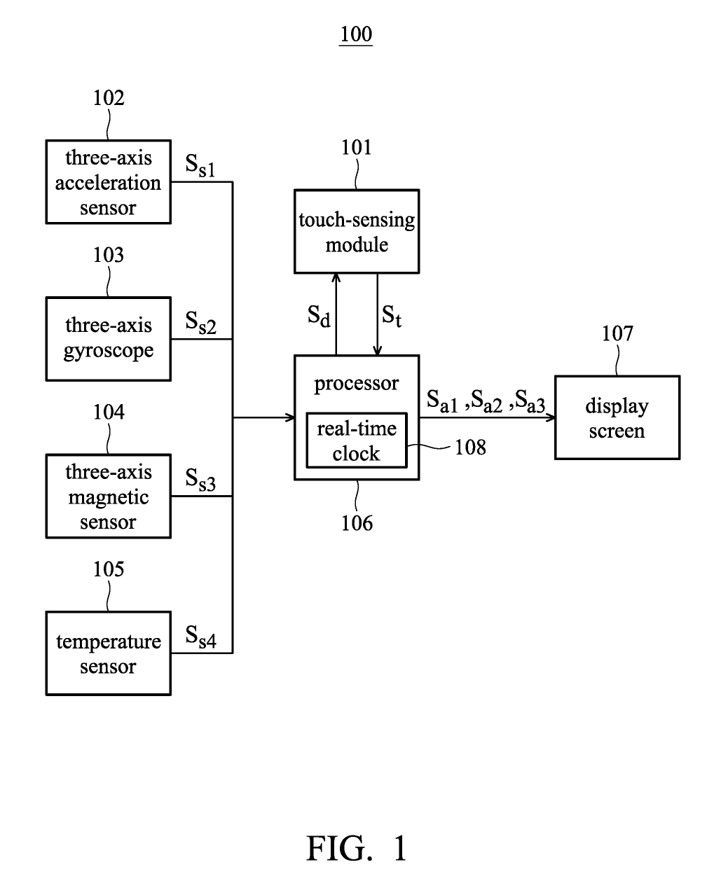

FIG. 1 is a block diagram of the portable electronic device in accordance with an embodiment of the invention. The portable electronic device 100 includes a touch-sensing module 101, a three-axis acceleration sensor 102, a three-axis gyroscope 103, a three-axis magnetic sensor 104, a temperature sensor 105, a processor 106, and a display screen 107. The portable electronic device 100 can be a personal digital assistant, a smartphone, a tablet, or a combination of the above devices, such as a transformer pad. The touch-sensing module 101 can be a touch panel, and is configured to generate a touching sensing signal St according to at least one touch action or one drag action corresponding to a touching object. The touching object can be a finger of the user, a stylus, or any object that can enable the touch-sensing electrodes. The three-axis acceleration sensor 102, the three-axis gyroscope 103, and the three-axis magnetic sensor 104 output a first sensing signal Ss1, a second sensing signal Ss2, and a third sensing signal Ss3, respectively. The processor 106 receives the touch-sensing signal St and the first sensing signal Ss1 from the touch-sensing module 101 and the three-axis acceleration sensor 102, respectively, and determines whether to enter a safe operation mode according to the touch-sensing signal St and the first sensing signal Ss1. When the processor 106 enters the safe operation mode, the processor 106 outputs a first adjustment signal Sa1 or a second adjustment signal Sa2 according to the first sensing signal Ss1, the second sensing signal Ss2, the third sensing signal Ss3, and/or the touch-sensing signal St for controlling the display screen 107 to decrease the brightness of the display screen 107. The processor 106 further includes a real-time clock 108 for outputting the current time according to the time zone of the portable electronic device 100.

According to an embodiment of the present invention, the three-axis acceleration sensor 102 continuously outputs the first sensing signal Ss1 corresponding to gravity variations of the x-axis, y-axis and z-axis to the processor 106, and the process 106 determines whether the gravity variation is greater than a predetermined threshold according to the first sensing signal Ss1. When the processor 106 determines that the gravity variations of a horizontal direction and a vertical direction are greater than the predetermined thresholds and are presented as a periodic variation according to the first sensing signal Ss1, the processor 106 determines that the portable electronic device 100 is in a state of motion. Then the processor 106 determines whether the user is using the portable electronic device 100 according to the operation mode of the user interface and the touch-sensing signal output from the touch-sensing module 101. For example, when the processor 106 determines that the user interface is not operating in a lock mode or an idle mode (e.g., by determining a flag of an operation system), the call module of the portable electronic device 100 is disabled, and the touch-sensing module 101 continuously receives a touch-sensing signal St, the processor 106 determines that the user is using the portable electronic device for browsing the Internet, operating an application, or watching a video rather than making a call. Thus, for the safety of the user, the processor 106 outputs a first adjustment signal Sa1 to the display screen 107 immediately, and the display screen 107 decreases the brightness of the display screen from the normal brightness to a first brightness to enter a safe operation mode for reminding the user. The first brightness can be defined by the user, and it is used to make it so that the content shown on the display screen 107 cannot be seen clearly. Otherwise, when the processor 106 determines that the portable electronic device 100 stops moving or is making a call, the processor 106 outputs a second adjustment signal Sa2 to the display screen 107, and the display screen 107 increases the brightness from the first brightness to the normal brightness according to the second adjustment signal Sa2.

According to another embodiment of the present invention, the processor 106 further determines whether the portable electronic device 100 is in the call mode according to a distance sensor or a biometric system built inside the portable electronic device 100. For example, the processor 106 determines whether the user is using the portable electronic device 100 by using the distance sensor to determine whether there is an object, e.g., the face of the user, close to the portable electronic device 100, or using the biometric system to determine whether the user is facing the display screen 107. Similarly, when the processor 106 determines that the user is using the portable electronic device 100 while in a state of motion, the processor 106 outputs the first adjustment signal Sa1 for decreasing the brightness of the display screen 107.

According to another embodiment of the present invention, the processor 106 further determines whether the user is using the portable electronic device 100 while walking at night. For example, when the processor 106 determines that the time zone of user is in a specific time period, e.g., 6 p.m. to 6 a.m., according to the current time output from the real-time clock 108, the portable electronic device 100 is in a state of motion, and the user is continuously using the portable electronic device, such as the touch-sensing module 101 continuously receiving a touch-sensing signal St or the biometric system determining that the user is facing the display screen 107, the processor 106 outputs a disabling signal Sd to the touch-sensing module 101 and/or the display screen 107 for disabling the touch-sensing module 101 and/or the display screen 107, which makes it so that the portable electronic device 100 cannot be used by the user, thereby preventing accidents.

According to another embodiment of the present invention, when the processor 106 determines that the portable electronic device 100 is in a state of motion, and the processor does not execute any application or is in an idle mode, the processor 106 outputs a third adjustment signal Sa3 to control the display screen 107 to decrease the brightness to a second brightness that is lower than the first brightness, for reducing the power consumption of the portable electronic device.

According to another embodiment of the present invention, the processor 106 further adjusts the power consumption of the processor 106 according to a temperature signal Ss4 output from the temperature sensor 105 and the state of motion of the portable electronic device 100. The temperature sensor 105 is used to detect the temperature of the portable electronic device 100, such as the temperature of a battery or the processor. For example, when the temperature sensor 105 detects that the temperature of the battery, the processor 106, or the case of the portable electronic device 100 is too high, such as the portable electronic device 100 having an internal temperature of 62°, or the temperature of the case is over 40°, the processor 106 decreases the power consumption of the processor 106, e.g., from 6 W to 4 W, according to a fourth adjustment signal and a lookup table for preventing overheating of the portable electronic device 100.

According to an embodiment, the portable electronic device 100 further includes a three-axis gyroscope 103 and/or a three-axis magnetic sensor 104, which are configured to monitor the state of motion of the portable electronic device 100. When the processor 106 determines that all of the sensing signals received from the three-axis acceleration sensor 102, the three-axis gyroscope 103, and/or the three-axis magnetic sensor 104 are greater than the corresponding predetermined thresholds, the processor 106 outputs a warning signal. For example, when the first sensing signal Ss1 output from the three-axis acceleration sensor 102 is greater than 1 G, the second sensing signal Ss2 output from the three-axis gyroscope 103 is greater than 10 degrees/second, and the third sensing signal Ss3 output from the three-axis magnetic sensor 104 is greater than 0.2 gauss, the processor 106 outputs the warning signal for enabling a voice module, such as a speaker of the portable electronic device 100, to output a warning ringtone. Furthermore, the processor 106 controls the user interface to enter a lock mode for warning the user that the portable electronic device 100 has been dropped, and for preventing other people from stealing the data in the portable electronic device 100.

In addition, the processor 106 further determines the length of the warning ringtone according to the power remaining in the portable electronic device 100. For example, when the remaining power of the portable electronic device 100 is greater than 10%, the processor 106 outputs the warning ringtone for 5 minutes. Otherwise, when the remaining power of the portable electronic device 100 is less than or equal to 10%, the processor 106 outputs the warning ringtone for only 1 minute. Furthermore, when the warning ringtone stops sounding and the user interface is still in the lock mode, the processor 106 stores tasks that are not finished, and/or data of applications that are still running, to a storage device such as solid state disk, and enters a hibernation mode for reducing power consumption of the portable electronic device 100.

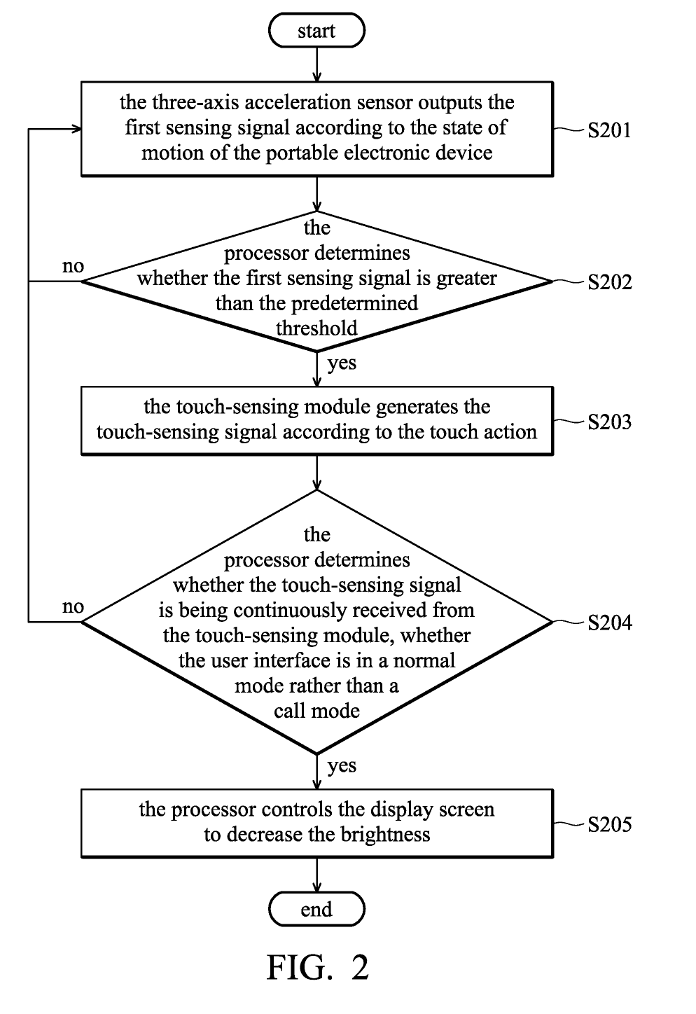

FIG. 2 is a flow chart of the portable electronic device operating method in accordance with an embodiment of the invention. In step S201, the three-axis acceleration sensor 102 outputs the first sensing signal Ss1 according to the state of motion of the portable electronic device 100. In step S202, the processor 106 determines whether the first sensing signal Ss1 is greater than the predetermined threshold output from the three-axis acceleration sensor 102. When the first sensing signal Ss1 is greater than the predetermined threshold, the method proceeds to step S203, the touch-sensing module 101 generates the touch-sensing signal St according to the touch action of the touching object. Otherwise, when the first sensing signal Ss1 is less than the predetermined threshold, the method returns to step S201, the processor 106 receives the first sensing signal Ss1 and determines whether the first sensing signal Ss1 is greater than the predetermined threshold once again. In step S204, the processor 106 determines whether the touch-sensing signal St is being continuously received from the touch-sensing module 101, whether the user interface is in a normal mode, and whether the portable electronic device does not make a call for longer than the predetermined time. When the touch-sensing signal St is continuously being received from the touch-sensing module 101, the user interface is in a normal mode, and the portable electronic device has not made a call for more than the predetermined time, the method proceeds to step S205, the processor 106 controls the display screen 107 to decrease the brightness from the normal brightness to the first brightness for entering the safe operation mode. Otherwise, the method proceeds back to step S201, and the processor 106 receives the first sensing signal Ss1 and determines once again whether the first sensing signal Ss1 is greater than the predetermined threshold.

As described above, according to the portable electronic device and the portable electronic device operating method of the present invention, when the processor of the portable electronic device determines that the user is using the portable electronic device while moving, the processor can adjust the brightness of the display screen as a way of reminding the user to pay attention to his surroundings. Furthermore, the processor can disable the display screen or the touch-sensing module to make it so the portable electronic device cannot be used by the user while moving at night, thereby protecting the user's safety.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A portable electronic device, comprising:
a three-axis acceleration sensor, outputting a first sensing signal according to a state of motion of the portable electronic device;
a touch-sensing module, generating a touch-sensing signal according to a touch action of a touching object;
a processor, receiving the first sensing signal and the touch-sensing signal, and executing a user interface, wherein when the first sensing signal is greater than a predetermined threshold, the processor determines that the portable electronic device is in a state of motion; and
a display screen, displaying the user interface;
wherein when the portable electronic device is in a state of motion, the processor continuously receives the touch-sensing signal and the user interface is in a normal mode rather than a call mode for longer than a predetermined time, the processor controls the display screen to decrease brightness from an original value to a first value for entering a safe operation mode.

2. The portable electronic device as claimed in claim 1, further comprising:
a real-time clock, outputting a current time;
wherein when the processor determines that the current time is within a predetermined time period, the portable electronic device is in a state of motion, and the processor continuously receives the touch-sensing signal, the processor disables the display screen and/or the touch-sensing module.

3. The portable electronic device as claimed in claim 1, wherein when the processor determines that the portable electronic device is in a state of motion and the processor is in an idle mode, the processor controls the display screen to decrease the brightness from the original value to a second value, wherein the second value is smaller than the first value.

4. The portable electronic device as claimed in claim 1, further comprising:
a temperature sensor, sensing a temperature of the portable electronic device and outputting a temperature signal corresponding to the temperature;
wherein when the portable electronic device is in a state of motion and the temperature signal is greater a predetermined temperature, the processor decreases power consumption of the processor.

5. The portable electronic device as claimed in claim 1, further comprising:
a three-axis gyroscope, outputting a second sensing signal according to the state of motion of the portable electronic device; and
a three-axis magnetic sensor, outputting a third sensing signal according to the state of motion of the portable electronic device;
wherein when the first sensing signal is greater than a first threshold value, the second sensing signal is greater than a second threshold value, and the third sensing signal is greater than a third threshold value, the processor outputs a warning signal for enabling a voice module to output a warning ringtone and enabling the portable electronic device to enter a lock mode.

6. A portable electronic device operating method, comprising:
outputting, via a three-axis acceleration sensor, a first sensing signal according to a state of motion of a portable electronic device;
generating, via a touch-sensing module, a touch-sensing signal according to a touch action of a touching object;
receiving, via a processor, the first sensing signal and the touch-sensing signal;
executing, via the processor, a user interface;
determining, via the processor, whether the first sensing signal is greater than a predetermined threshold;
determining, via the processor, that the portable electronic device is in a state of motion when the first sensing signal is greater than a predetermined threshold; and
controlling, via the processor, a display screen to decrease brightness from an original value to a first value for entering a safe operation mode when the portable electronic device is in a state of motion, the processor continuously receives the touch-sensing signal and the user interface is in a normal mode rather than a call mode for longer than a predetermined time.

7. The portable electronic device operating method as claimed in claim 6, further comprising:
outputting, via a real-time clock, a current time; and
disabling, via the processor, the display screen and/or the touch-sensing module when the processor determines that the current time is within a predetermined time period, the portable electronic device is in a state of motion, and the processor continuously receives the touch-sensing signal.

8. The portable electronic device operating method as claimed in claim 6, further comprising:
controlling, via the processor, the display screen to decrease the brightness from the original value to a second value when the processor determines that the portable electronic device is in a state of motion and the processor is in an idle mode;
wherein the second value is smaller than the first value.

9. The portable electronic device operating method as claimed in claim 6, further comprising:
sensing, via a temperature sensor, a temperature of the portable electronic device and outputting a temperature signal corresponding to the temperature; and
decreasing, via the processor, power consumption of the processor when the portable electronic device is in a state of motion and the temperature signal is greater a predetermined temperature.

10. The portable electronic device operating method as claimed in claim 6, further comprising:
outputting, via a three-axis gyroscope, a second sensing signal according to the state of motion of the portable electronic device;
outputting, via a three-axis magnetic sensor, a third sensing signal according to the state of motion of the portable electronic device;
outputting, via the processor, a warning signal for enabling a voice module to output a warning ringtone, and enabling the portable electronic device to enter a lock mode when the first sensing signal is greater than a first threshold value, the second sensing signal is greater than a second threshold value, and the third sensing signal is greater than a third threshold value.
